(19) United States
(12) Patent Application Publication
(10) Pub. No.: US 2020/0347634 A1
(43) Pub. Date: Nov. 5, 2020

(54) Self-Erecting Tower System and Associated Methods

(71) Applicant: Will Power LLC, Abu Dhabi (AE)

(72) Inventors: Usman Fateh, Riyadh (SA); Mohammad Zahoor, Dubai (AE)

(73) Assignee: Will Power LLC, Abu Dhabi (AE)

(21) Appl. No.: 16/865,057

(22) Filed: May 1, 2020

Related U.S. Application Data
(60) Provisional application No. 62/841,594, filed on May 1, 2019.

(51) Int. Cl. E04H 12/34; F03D 13/20

(52) U.S. Cl. CPC E04H 12/344; F03D 13/20

(57) ABSTRACT

A self-erecting structure system including an external structure apparatus including a plurality of external structure modules, each module comprising a plurality of legs, an internal structure apparatus configured to be temporarily be positioned within an area bounded by the external structure apparatus, the internal structure apparatus comprising a plurality of internal structure modules, and a platform member comprising, an inner aperture through which the internal structure apparatus may pass, an internal structure locking device, a plurality of outer apertures through which legs of the external structure apparatus may pass, a plurality of external structure locking devices, a primary lifting system, and a secondary lifting system configured. One of the primary lifting system and the second lifting system may raise the internal structure apparatus until a lower end thereof can be fixedly attached to the platform member. The platform member is configured to fixedly attach to the internal structure apparatus.

### RELATED APPLICATIONS

This application claims priority under 35 U.S.C. § 119(e) of U.S. Provisional Patent Application Ser. No. (Attorney Docket No. 4339.00003) filed on May 1, 2019 and titled Embodiments of Self-Assembling Tower and Associated Methods and Implementations Thereof. The contents of these applications are incorporated herein by reference.

### FIELD OF THE INVENTION

The present invention relates to systems and methods for self-erection of structures generally, with some embodiments directed to towers.

### BACKGROUND OF THE INVENTION

The wind industry tends to exploit other on-shore locations with greater wind availability or to improve the already existing locations. To maximize the amount of energy produced at on-shore locations with less wind resource availability, or to improve already existing locations, the strategies adopted and those that set the market trends should be made by increasing the hub height. The wind speed increases with height due to friction against the ground, which leads to the wind shear profile. Since the energy produced changes with the cube of the wind speed, small increases in height allow for considerable increases in production.

To provide a solution to the problem of using areas with high winds but that are already occupied with other wind turbines, the possibility to replace the old turbines with new, taller turbines is proposed.

Along this line of using the already existing locations, and using the automatic raising system described in PCT Patent Application Publication No. WO/2015/150594, a solution is presented for the raising of wind turbines that are operating in already existing locations, or for the raising of new wind turbines that require a greater height, which the conventional towers cannot satisfy.

A second problem that exists in the art is a solution to installing 120 to 180 meter hybrid or lattice towers. Since this type of installation currently implies a significant increased cost because the cranes to be used are very scarce in the market, creating significant scheduling problems. For towers over 120 m, it is very difficult to locate an economically viable assembly system.

For example, German Patent DE10111280 discloses a method and a device in order to be able to manufacture wind power plants in high altitudes. More in particular, it discloses a platform which can be displaced between a lowered position and a raised position, the stroke of which corresponds to the height of the mast segment which is to be installed next in each case and which has fastening means for releasably fixing the lowest mast segment of the mast section to be lifted is equipped, expediently there is also a guy device which has traction means which are variable in terms of their length and which allow the mast section, which grows in height, to be braced laterally relative to the ground. the vertical “stacking” of the mast segments does not take place by placing them on top of one another, but rather by “weft-wise” assembly from below, in each case the already erected mast section being raised and the next mast segment being inserted under the raised mast section . The assembly of the mast segments can concentrate on an area close to the ground, regardless of the height of the completed mast. The aforementioned German document presents a plurality of disadvantages such as the need for traction means which are distributed obliquely downward over the mast circumference to the winding device which is in turn installed at a distance from the foundation, requiring a high ground cover ratio for the installation.

U.S. Patent Application Publication No. 2014/260076 discloses a method of self-erecting a jacking tower includes extending a lift assembly, inserting a first module assembly below the extended lift assembly, lowering the lift assembly around the first module assembly, engaging the lift assembly with the first module assembly, extending the lift assembly with the first module assembly engaged, inserting a second module assembly below the extended lift assembly, lowering the lift assembly, and coupling the first and second module assemblies. The self-erecting method therein described is not compatible with a hybrid tower including a concrete tower. Moreover, it requires an excess of transitional complex pieces for the correct installation thereof.

U.S. Patent Application Publication No. 2017/321659 discloses a tower assembly which includes a lattice tower portion, a tubular tower portion, and a transition region therebetween. The lattice tower portion includes a plurality of structural members connected together to define an open lattice tower. Further, the structural members include a plurality of supports and a plurality of cross-support members. The cross-support members are connected between the supports so as to define one or more openings. The tubular tower portion includes a lower portion and an upper portion. The first transition region includes a single-piece connection structure, a plurality of arm members, and a plurality of node connectors. The connection structure has a circumferential body configured to receive the lower portion of the tubular tower portion therein. Further, the node connectors join the plurality of supports of the lattice tower portion to the connection structure via the plurality of arm members. However, this solution does not address avoiding a plurality of welded joints at the transition between the steel tubular portion and the lattice frame structure. No self-erecting solution is therein addressed.

German Patent Application Publication No. DE102006056274 relates to a tower of a wind power installation with a lattice tower-shaped lower part comprising three quoins and an upper part in the form of a tubular tower, preferably with a substantially circular cross section, being joined the upper part and the lower part in the transition zone. The object of the aforementioned patent application is to achieve an efficient and uniform flow of force from the tubular tower made in a circular way, as an enveloping supporting structure, to the tower in angular latticework, with a discrete load path through the quoins. This invention does not address a self-erecting apparatus and/or method and does not suggest a potential solution.

Furthermore, for example, U.S. Patent Application Publication No. 2016/230745 discloses a transition body with the object of configuring and modifying said transition body and the tower so that the assembly expense is lowered and the flow of force can be improved without this leading to a disproportionate increase in the transport expense. Specifically, said transition body is adapted for arrangement between an upper tower section and a lower tower section of a tower for a wind power station, with an essentially annular upper connection flange for joining the transition body to an upper tower section and with at least three essentially annular lower connection flanges each for joining to a corner leg of a lower tower section.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a self-erecting structure system comprising an external structure apparatus comprising a base module comprising a plurality of base leg members configured to fixedly attach to an anchoring structure at a lower end thereof and a plurality of bracing members configured to fixedly attach to adjacent base leg members. The self-erecting structure system further comprises a plurality of intermediate modules comprising a plurality of intermediate leg members configured to attach to at least one of an upper end of a base leg member and an upper end of an intermediate leg member at a lower end thereof and a plurality of bracing members configured to fixedly attach to adjacent intermediate leg members. The self-erecting structure system further comprises an upper module comprising a plurality of upper leg members and a plurality of bracing members configured to fixedly attach to adjacent upper leg members.

The self-erecting structure system further comprises an internal structure apparatus configured to be temporarily be positioned within an area bounded by the external structure apparatus, the internal structure apparatus comprising a plurality of internal structure modules. The self-erecting structure system further comprises a platform member comprising an inner aperture within which the internal structure apparatus may pass through, an internal structure locking device configured to lock the platform member to the internal structure, a plurality of outer apertures through which one of a base leg member, and intermediate leg member, and an upper leg may pass through, a plurality of external structure locking devices configured to lock the platform member to at least one of the base leg members, the intermediate leg members, and the upper leg members, a primary lifting system configured to removably attach to one of the external structure apparatus and internal structure apparatus to elevate the platform member, and a secondary lifting system configured to removably attach to an upper module or a portion thereof or an internal structure module, and further configured to lift the upper module and portions thereof, and internal structure modules and portions thereof. One of the primary lifting system and the second lifting system may be configured to raise the internal structure apparatus until a lower end thereof can be fixedly attached to the center member. The center member may be configured to fixedly attach to the lower end of the internal structure apparatus in an installed configuration.

In some embodiments, the platform member may comprise a center member comprising the inner aperture and a plurality of platform arms extending outward from the center member, the plurality of platform arms each comprising an outer aperture of the plurality of outer apertures.

In some embodiments, the primary lifting system may comprise a plurality of primary lifting devices. In further embodiments, the plurality of primary lifting devices may comprise a number of primary lifting devices equal in number to the number of arms comprised by the plurality of outer apertures and fixedly attached to the platform member and each primary lifting device may be fixedly attached to an arm of the plurality of arms. In additional embodiments, at least one primary lifting device of the plurality of primary lifting devices may comprise a crane apparatus. In some embodiments, the primary lifting system may comprise a least one of a strand jack, a rack and pinion system, a winch, a hoist, a pinned climbing jack system, a lifting ratchet system, an electric linear actuator, a hydraulic linear actuator, and a reciprocating hydraulic ram.

In some embodiments, the secondary lifting system may comprise a plurality of secondary lifting devices. In further embodiments, the plurality of secondary lifting devices may comprise a number of secondary lifting devices equal in number to the number of outer apertures fixedly attached to the platform member. In some embodiments, at least one secondary lifting device of the plurality of secondary lifting devices may comprise a crane apparatus.

In some embodiments, the platform member may comprise a load attachment apparatus configured to attach to a load and the load may be elevated as the platform member is elevated. In some embodiments, the internal structure apparatus may be cylindrical and the inner aperture may be positioned at a center of the center member. In some embodiments, the internal structure apparatus may be a lattice structure comprising a plurality of internal leg members and a plurality of internal bracing members configured to fixedly attach to adjacent internal leg members. The platform member may comprise a plurality of inner apertures configured to permit an internal leg member of the plurality of internal leg members to pass therethrough.

In some embodiments, at least one of the plurality of outer apertures is configured to facilitate the a base leg member, an intermediate leg member, or an upper leg member positioned to be non-parallel with the other leg members and non-orthogonal to a plane defined by the platform member. In some embodiments, each of the primary lifting system and the secondary lifting system may comprise at least one of a hydraulic system and a pneumatic system. In some embodiments, each of the primary lifting system and the secondary lifting system may comprise at least one of a linear system and a rotary system.

In some embodiments, the self-erecting structure system may further comprise a second internal structure apparatus configured to be temporarily be positioned within an area bounded by the internal structure apparatus, the second internal structure apparatus comprising a plurality of second internal structure modules and a load comprising a second platform member. The second platform member may comprise an inner aperture within which the second internal structure apparatus may pass through, a second internal structure locking device configured to lock the second platform member to the second internal structure, a plurality of second outer apertures through which a leg member of the internal structure may pass through, a plurality of second external structure locking devices configured to lock the second platform member to a leg member of the internal structure, a primary lifting system configured to removably attach to one of the internal structure apparatus and the second internal structure apparatus to elevate the second platform member, and a secondary lifting system configured to removably attach to an upper module or a portion thereof or an internal structure module to raise the upper module or portion thereof of internal structure module to the second platform member.

Further embodiments of the invention may be directed to a method of constructing a structure comprising positioning above an anchoring structure a platform member comprising an inner aperture, an internal structure locking device, a plurality of outer apertures, a plurality of external structure locking devices, a primary lifting system, and a secondary lifting system. The method further comprises positioning a plurality of base leg members of a base module through the outer apertures and attaching a lower end of the plurality of base leg members to the anchoring structure. The method further comprises attaching the primary lifting system to at least one of the base leg members of the plurality of base leg members and elevating the platform member to an upper end of the plurality of base leg members using the primary lifting system. The method further comprises lifting a plurality of intermediate leg members to the platform member using the secondary lifting system, fixedly attaching a lower end of the plurality of intermediate leg members to the upper end of the plurality of base leg members, and elevating the platform member to an upper end of the plurality of intermediate leg members using the primary lifting system. The method further comprises lifting a plurality of upper leg members to the platform member using the secondary lifting system, fixedly attaching a lower end of the plurality of upper leg members to the upper end of the plurality of intermediate leg members, and elevating the platform member to an upper end of the plurality of upper leg members using the primary lifting system. The method further comprises fixedly attaching the platform member to an upper end of the upper leg members, lifting an internal structure apparatus using one of the primary lifting system and the second lifting system, and fixedly attaching the internal structure apparatus to the platform member.

In some embodiments, the method may further comprise attaching a load to the platform member, attaching the load to an upper end of the internal structure apparatus, and detaching the load from the platform member prior to lifting the internal structure apparatus. In some further embodiments, the load may be attached to the platform member at a location remote from the anchoring structure, the method further comprising transporting the platform member with the load attached thereto to the anchoring structure.

In some embodiments, the anchoring structure may be at least one of caissons, piles, piers, drilled shafts, footings, and any other foundation. In some embodiments, the anchoring structure is operable to move itself and constructed structure attached thereto, the method further comprising operating the anchoring structure to move the constructed structure.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a portion of a self-erecting structure system according to an embodiment of the invention.

FIGS. 2A-G are perspective views of a self-erecting structure system according to an embodiment of the invention constructing a structure.

FIGS. 3A-E are perspective views of a self-erecting structure system according to an embodiment of the invention constructing a structure.

FIGS. 4A-B are perspective views of a self-erecting structure system according to an embodiment of the invention depicting the raising of an internal structure thereof.

FIGS. 5A-B are perspective views of a self-erecting structure system according to an embodiment of the invention depicting the raising of an internal structure thereof.

FIGS. 6A-C are views of the installation of a platform of a self-erecting structure system according to an embodiment of the invention.

FIG. 7 is a perspective view of a self-erecting structure system according to an embodiment of the invention.

FIGS. 8A-B are perspective views of a self-erecting structure system according to an embodiment of the invention including a bridge member.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

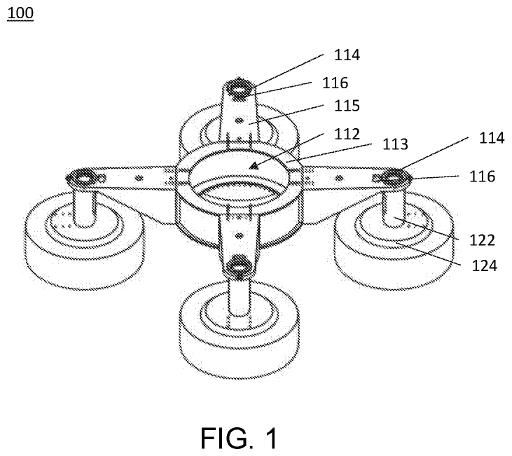

An embodiment of the invention, as shown and described by the various figures and accompanying text, provides a system and method for a self-erecting structure system. Referring to FIG. 1, a portion of a self-erecting structure system 100 according to an embodiment of the invention is presented. The self-erecting structure system 100 shown in FIG. 1 includes a platform member 110 and a base module 120. The platform member 110 defines an inner aperture 112 and a plurality of outer apertures 114. The inner aperture 112 may be configured to permit an internal structure apparatus to pass through. In the current embodiment, the inner aperture 112 is positioned at the center of the platform member 110. It is contemplated and included within the scope of the invention that the inner aperture 112 may be positioned so as to be eccentric to the center of the platform member 110. Additionally, while a single inner aperture 112 is depicted, it is contemplated and included within the scope of the invention that the platform member 110 may comprise a plurality of inner apertures 112. The number of inner apertures will depend on the type of structure the internal structure apparatus is, e.g. a single aperture to accommodate a monolithic structure or a plurality of apertures to accommodate a structure with multiple elements, such as a trellised structure. Furthermore, the inner aperture 112 may have a geometry to conform to the geometry of the internal structure apparatus. While the inner aperture 112 of the present embodiment is circular, all other shapes are contemplated and included within the scope of the invention, including, but not limited to, square, triangular hexagonal, L-shaped, I-shaped, C-shaped, and the like. In the current embodiment, the platform member 110 comprises a center member 113 that defines the inner aperture 112.

The plurality of outer apertures 114 may be configured to permit portions of an external structure apparatus to pass therethrough. Any number of outer apertures 114 is contemplated and included within the scope of the invention. While the present embodiment comprises four outer apertures 114, three or more outer apertures 114 is specifically contemplated. The number of outer apertures 114 may be equal in number to the number of leg members comprised by the external structure apparatus, which is typically three or four, but may be greater. Similar to the inner aperture 112, the outer apertures may have a geometry configured to conform to the geometry of the leg members of the external structure apparatus, including the shapes mentioned herein above. In the current embodiment, the platform member 110 comprises a plurality of arms 115, each arm of the plurality of arms 115 defining an outer aperture 114. The plurality of arms 115 may be attached to and extend outward from the center member 113. In some embodiments, the plurality of arms 115 may be formed separate from the center member 113 and attached after being formed. In some embodiments, the plurality of arms 115 and the center member 113 may be integrally formed as a single structure.

The platform member 110 may further comprise a plurality of external structure locking devices 116. The plurality of external structure locking devices 116 may be configured to lock the platform member 110 to a portion of the external structure apparatus, preventing the platform member from translating vertically. The external structure locking devices 116 may be selectively locked and unlocked, allowing the platform member 110 to be elevated or de-elevated as desired and then locked at a particular elevation for conducting construction activity.

A base module 120 of an external structure apparatus is also shown. The base module comprises a plurality of base leg members 122 having lower ends thereof configured to fixedly attach to an anchoring structure for the external structure apparatus. The anchoring structure may be any type of foundation as is known in the art, including, but not limited to, of caissons, piles, piers, drilled shafts, footings. Accordingly, the base leg members 122 may be configured to facilitate attachment to these various types of foundation. In the present embodiment, the base leg members 122 comprise flange footings 124 that extend radially outward from a lower end of the base leg members 122.

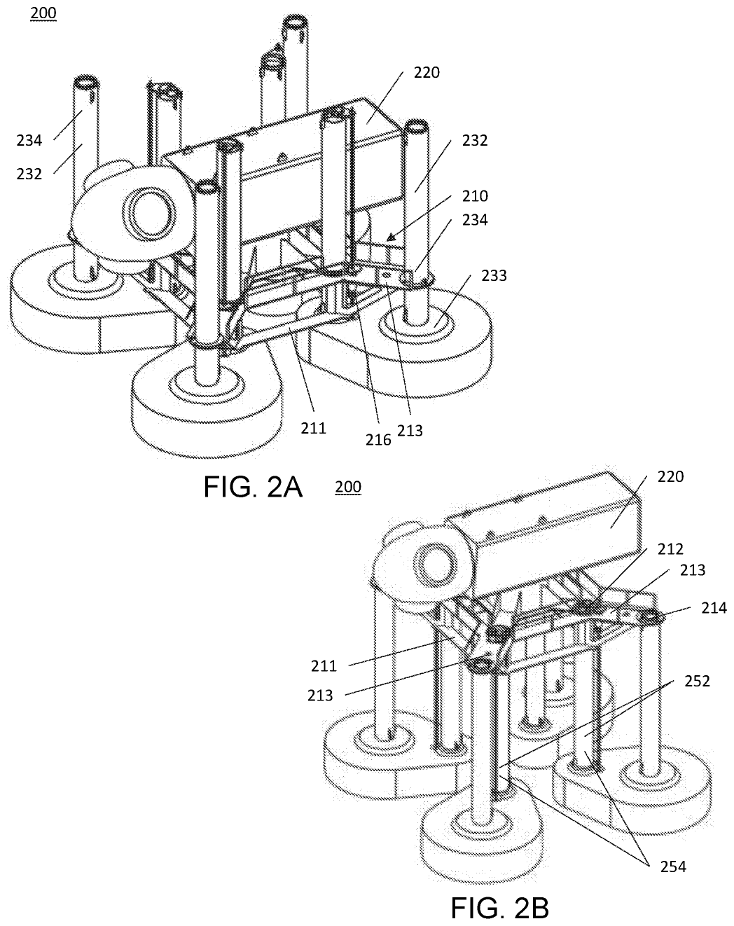

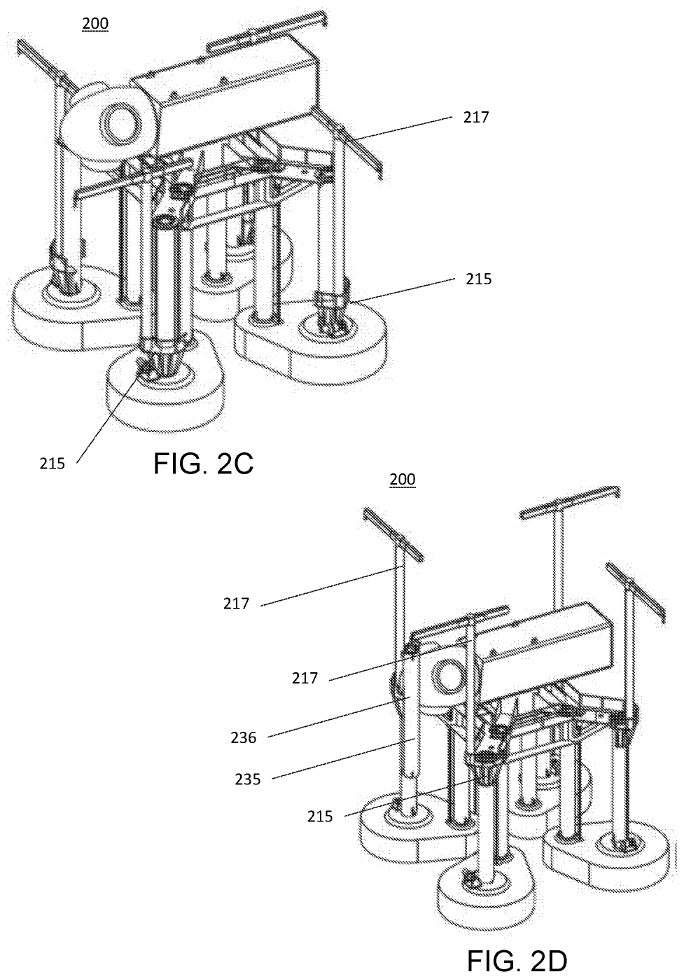

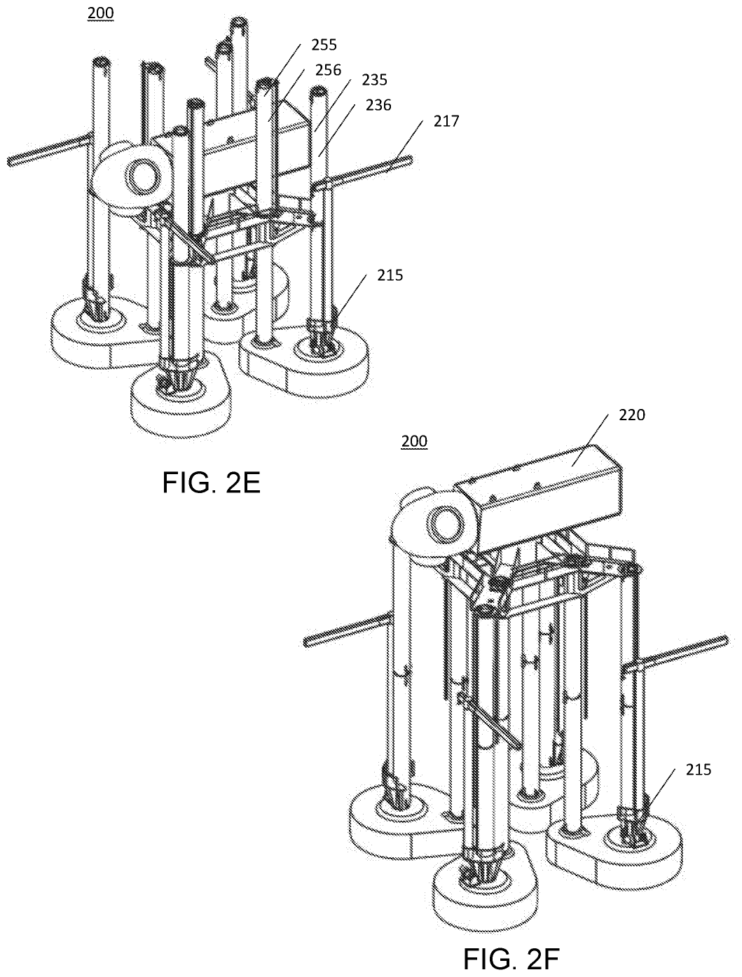

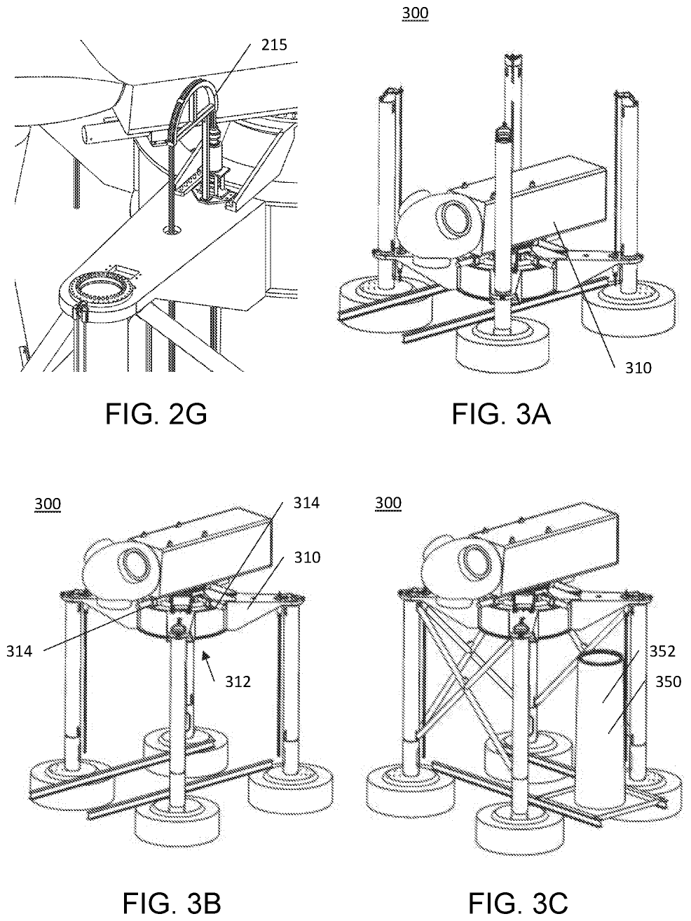

Referring now to FIGS. 2A-G, a self-erecting structure system 200 and a method of construction associated therewith is shown. The self-erecting structure system 200 comprises a platform member 210 having a center member 211 comprising a plurality of inner apertures 212 and a plurality of arms 213 with each arm comprising an outer aperture 214.

In the present embodiment, the self-erecting structure system 200 further comprises a load 220. The load 220 may be removably attached to the platform member 210. The load 220 may be advantageously attached to the platform member 210 at ground level, and even prior to construction, as will be discussed in greater detail herein below. The load 220 may include any device, apparatus, or structure that is intended to be positioned at an elevation on the structure to be constructed. Types of loads include, but are not limited to, wind turbines and their constituent parts, such as nacelles, communications devices such as mobile phone transceivers, electrical infrastructure devices, liquid storage containers, and the like. Accordingly, the platform member 210 may be configured to include a load attachment apparatus configured to facilitate the attachment and detachment of the load 220 thereto.

The self-erecting structure system 200 further comprises an external structure apparatus 230 and an internal structure apparatus 250. A base module 232 of the external structure apparatus 230 is shown, substantially similar to the base module 120 of FIG. 1. The base module 232 comprises a plurality of base leg members 234 with lower ends thereof 233 being configured to attach to an anchoring structure. The internal structure apparatus 250 of the current embodiment is a lattice-type, comprising a base module 252 that includes a plurality of leg members 254.

As shown in FIG. 2A, the base modules 232, 252 of the external and internal structure apparatuses 230, 250 may be attached to the anchoring structure and the platform member 210 may be installed such that portions of the external and internal structure apparatuses 230, 250 pass through the outer and inner apertures 214, 212. The platform member 210 may further comprise a primary lifting system 215, seen most clearly in FIG. 2F and FIG. 2G. The primary lifting system 215 may be configured to removably attach to one of the external structure apparatus 230 and the internal structure apparatus 250 to elevate the platform member 210. The primary lifting system 215 may comprise one or more primary lifting devices. The primary lifting devices may be any type of lifting device as is known in the art, including, but limited to, rotary and linear devices, electrical, hydraulic, and pneumatic devices, and specifically, strand jacks, rack and pinion systems, winches, hoists, pinned climbing jack systems, lifting ratchet systems, electric linear actuators, hydraulic linear actuators, screw jacks, and reciprocating hydraulic rams.

The platform member 210 may further comprise a secondary lifting system 216. The secondary lifting system 216 may be configured to removably attach to the internal structure module 250 and lift the internal structure module 250. The secondary lifting system 216 may comprise one or more secondary lifting devices that may be selected from the types of devices listed for the primary lifting devices above.

As shown in FIG. 2B, the primary lifting device 215 has been operated to elevate the platform member 210 from a first elevation towards a lower end of the base module 232 to an upper end thereof. Advantageously, the load 220 has also been elevated.

Referring now specifically to FIGS. 2C-G, it is shown that the primary lifting system 215 may comprise one or more crane apparatuses 217. Any type of crane apparatus as is known in the art is contemplated and included within the scope of the invention, including, but not limited to, jib arms, shear leg cranes, and the like. Any number of crane apparatuses 217 is contemplated and included within the scope of the invention. In the current embodiments, the number of crane apparatuses 217 is equal to the number of arms of the plurality of arms 213. It is contemplated and included within the scope of the invention that only a subset of the plurality of arms 217 and/or primary lifting devices may have a crane apparatus associated therewith. The crane apparatuses 217 may facilitate the lifting of additional parts of the external and internal structure apparatuses 230, 250 to enable construction of the structure. As shown in FIG. 2D, the crane apparatuses 217 may lift the constituent pieces of intermediate modules 235, 255 of the external and internal structure apparatuses 230, 250, each of the intermediate modules 235, 255 comprising a plurality of intermediate leg members 236, 256. The intermediate leg members 236, 256 may be configured to be fixedly attached at lower ends thereof to upper ends of the leg members 234, 254 of the base modules 233, 253, thereby creating the legs of the external and internal structure apparatuses 230, 250. As shown in FIG. 2D, an intermediate leg member 236 may be lifted by a crane member 217, and then as seen in FIG. 2E, the various parts of the intermediate modules 235, 255 may be installed. Further, upon installation of the intermediate modules 235, 255, the platform member 210 may be elevated to an upper end of the intermediate modules 235, 255 by operation of the primary lifting system 215. Again, the load 220 is advantageously elevated along with the platform member 210.

The installation of several intermediate modules 235, 255 of the external and internal structure apparatuses 230, 250, is contemplated and included within the scope of the invention. Any number of intermediate modules 235, 255 may be installed in order to achieve a desired height of the external structure apparatus 230, and by extension of the entire structure. Additional details regarding the external structure apparatus 230 are provided below.

Additionally, in some embodiments, the primary lifting system 215 may be configured to elevate itself along the external structure apparatus 230. In such embodiments, the primary lifting system 215 may be configured to detach itself from the platform member 210 while remaining attached to the external structure apparatus 230 and operate to elevate and de-elevate along the legs of the external structure apparatus 230.

It is contemplated and included within the scope of the invention that only a primary lifting system 215 may be comprised by the platform member 210. In such embodiments, the primary lifting system 215 may be configured to be selectively attached to one of the external structure apparatus 430 and the internal structure apparatus 450 at a given time. In such embodiments, the platform member 410 may not comprise a secondary lifting system.

In some embodiments, it may be necessary or desired for one, some, or all of the legs of the external structure apparatus 230 to be generally non-parallel with the other legs of thereof. In such embodiments, the outer apertures 214 may be configured to permit legs of the external structure apparatus to pass there through at non-parallel angles, such that the legs are not parallel to the platform module 210.

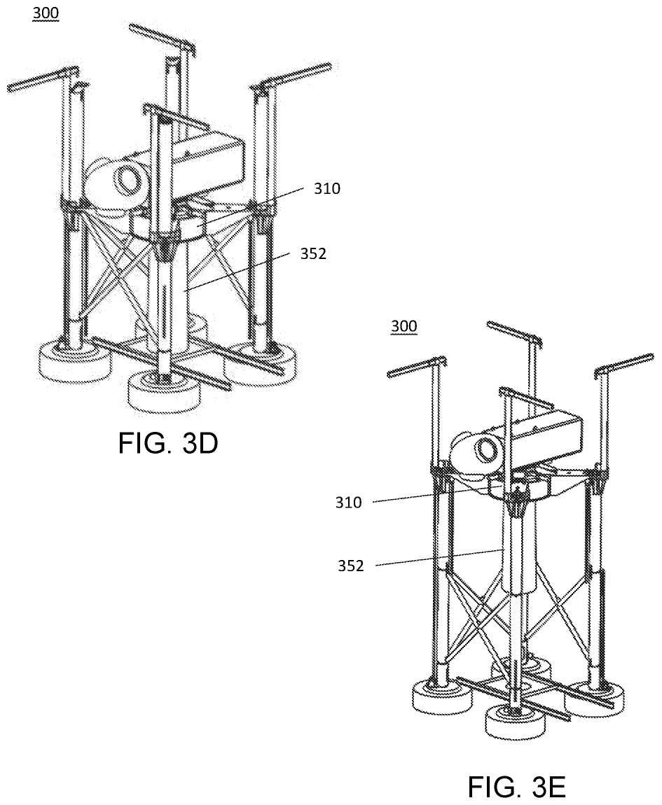

Referring now to FIGS. 3A-E, a similar self-erecting structure system 300 is presented, with the notable difference of the internal structure apparatus 350 being cylindrical. In such embodiments, an internal structure apparatus module 352 may be positioned underneath the platform member 310 by any means or method as is known in the art, including, but not limited to, a skid system. Such positioning may occur after the platform member 310 has been elevated to an elevation sufficient to permit the internal structure apparatus module 352 to be positioned there under. Upon being positioned under the platform member 310, the internal structure apparatus module 352 be passed at least partially through the inner aperture 312 of the platform member 210 and attached to the platform member 210, either by a secondary lifting system as described here<in above or by lowering the platform member 310 via the primary lifting system 325 as described herein above. Further, the platform member 310 may comprise one or more alignment apparatuses 314 configured to interface with and/or pass through an aperture of the internal structure apparatus module 352 to maintain a relative rotational alignment between the internal structure apparatus module 352 and the platform module. After such attachment, as shown in FIG. 3E, the platform module 310 may be elevated and may lift the internal structure apparatus module 352 therewith. Thereafter, additional internal structure apparatus modules may be attached to the already-attached modules by attaching their ends together by any means or method known in the art, including, but not limited to, welding, fasteners, interference fits, combinations thereof, and the like.

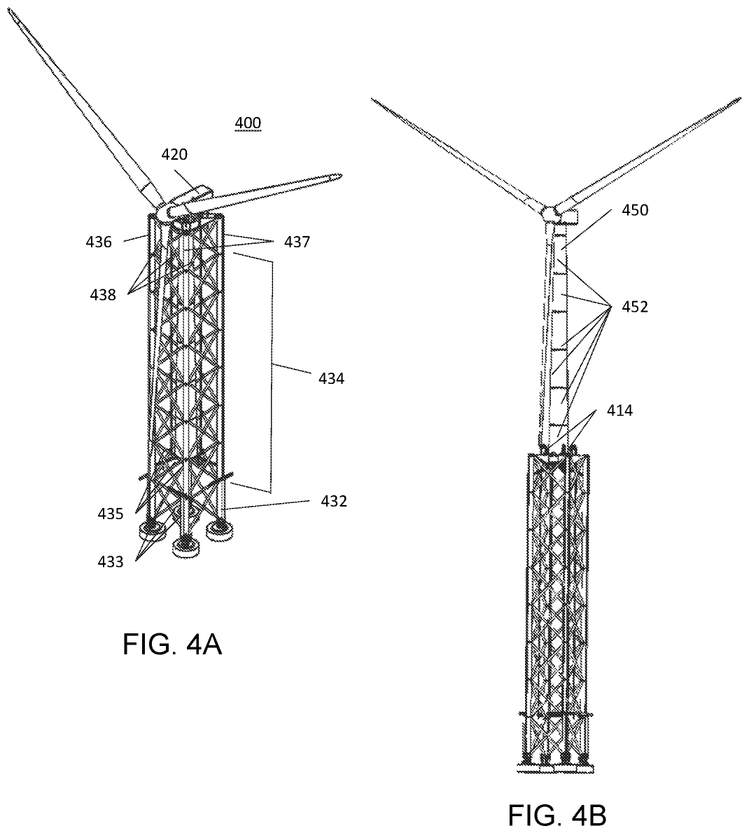

Referring now to FIGS. 4A-B, a self-erecting structure system 400 according to an embodiment of the invention is presented. In the current embodiment, the internal structure apparatus 450 is cylindrical and comprises a plurality of modules 452 that have been assembled and attached to one another to form the internal structure apparatus 450. The external structure apparatus 430 comprises a base module 432, a plurality of intermediate modules 434, and an upper module 436, the upper module 436 being configured such that leg members 437 thereof may be attached at lower ends to upper ends of leg members of the uppermost intermediate module of the plurality of intermediate modules 434, thereby completing the external structure apparatus 430. Moreover, each of the base module 432, the intermediate modules 434, and the upper module 436 may comprise bracing members 433, 435, 438, respectively, attached to adjacent leg members to improve the structural stability of the modules 432, 434, 436. Such bracing members 433, 435, 438 may be lifted during construction but one or both of crane structures of the primary and secondary lifting systems.

Once construction of the external structure apparatus 430 is complete, the internal structure apparatus 450 remains within a space bounded by the external structure apparatus 430. One or more external structure locking devices may be operated to lock the platform member 410 to the external structure apparatus 430 to prevent the relative movement thereof while permitting the disengagement of the primary lifting system 415 from the external structure apparatus 430 to facilitate the in the lifting of the internal structure apparatus 450, if so desired. The load 420 may be detached from the platform member 410 and fixedly attached to an upper end of the internal structure apparatus 430. Such attachment may be accomplished by any means or method as is known in the art, as described above. One the load 420 is attached to the internal structure apparatus 450, the secondary lifting system 414 may operate to lift the internal structure apparatus 450, translating the multiple plurality of modules 452 through an inner aperture of the platform member 410 as described hereinabove, until the entire or nearly the entire internal structure apparatus 450 is positioned above the platform member 410 and no longer within the area bounded by the external structure apparatus 430. Once so positioned, the platform member 410 may be fixedly attached to a lower portion of the internal structure apparatus 450, such as a lowest module 452 thereof. Such attachment may be accomplished by one or more internal structure locking devices comprised by the platform member 410, said internal structure locking devices being operable to prevent the unintended detachment of the internal structure apparatus 450 from the platform 410. Any type of locking system as is known in the art is contemplated and included within the scope of the invention. The platform member 410 remains installed on the structure, serving as the transitional piece between the external tower structure 430 and the internal tower structure 450.

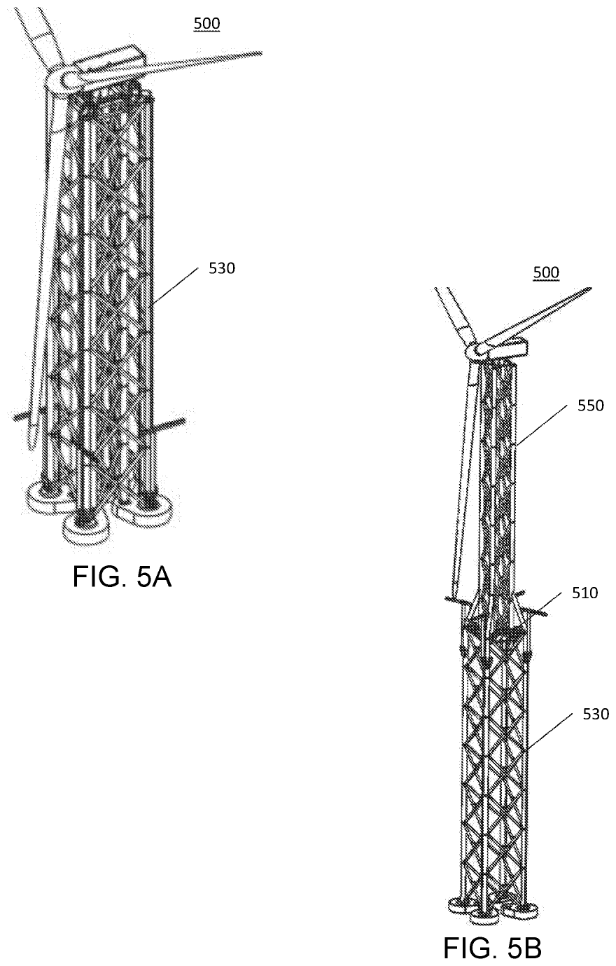

Referring now to FIGS. 5A-B a self-erecting structure system 500 according to an embodiment of the invention is presented. In the current embodiment, the internal structure apparatus 550 is a lattice structure. Similar to what is shown in FIGS. 4A-B, the internal structure apparatus 550 may be lifted from the bounded interior of the external structure apparatus 530 through the inner apertures of the platform member 510 and, upon reaching a desired elevation, locked to the platform member 510 by internal structure locking devices.

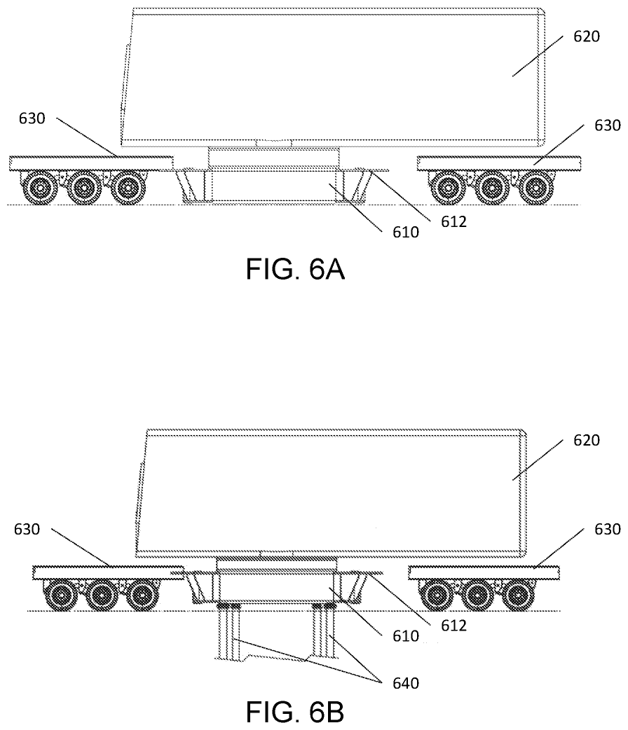

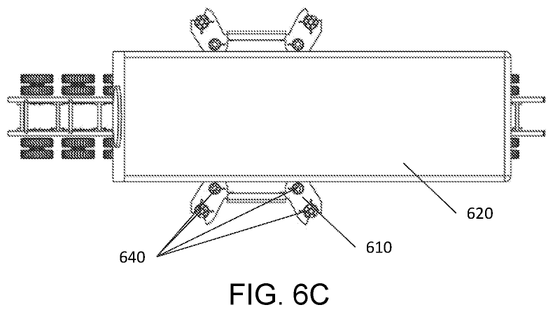

Referring now to FIGS. 6A-D, an additional aspect of the method of constructing a structure according to an embodiment of the invention is presented. In the present embodiment, the platform member 610 and the load 620 may be transported to the desired erection location by a transportation device 630. The transportation device 630 may be operable to transport the platform member 610 and the load 620, which may be attached at a location remote from the erection location, i.e. where an anchoring structure 640 is located, to the anchoring structure 640. Upon being transported, the platform member 610 may be positioned so as to be aligned with the anchoring structure 640 by a yawing structure 612 of the platform member. Once aligned, the transportation device 630 may be detached from one or both of the platform member 610 and the load 620 to enable attachment to the anchoring structure 630. Thereafter, base modules of one or both of the external structure apparatus and the internal structure apparatus may be attached to the anchoring structure 640 and the platform member 610, thus allowing construction to commence. Furthermore, the yawing structure 612 may be used at any point during construction to reorient the load 620 with respect to the platform member 610.

In some embodiments, the transportation device 630 may not be a discrete structure, but instead comprise a plurality of wheels, treads, or other ground interface devices and a motor or other driving device operable to turn the ground interface devices. The ground interface devices and the driving device may both be removably attachable to one or both of the platform member 610 and the load 620. In some embodiments, the driving device may be a vehicle to which the platform member 610 or the load 620 may be hitched. When attached and operated, the ground interface device and the driving device may transport the platform member 610 and the load 620 as described above to the desired location and then be detached.

In some embodiments, the anchoring structure to which a self-erecting structure system may be constructed upon may itself be operable to move once the structure is constructed. The anchoring structure may then be operate to move the structure. In further embodiments, the anchoring structure may be a “floating” structure, such as a vessel that may float in a body of water, such as on ships, on drilling platforms, and other similar watercraft.

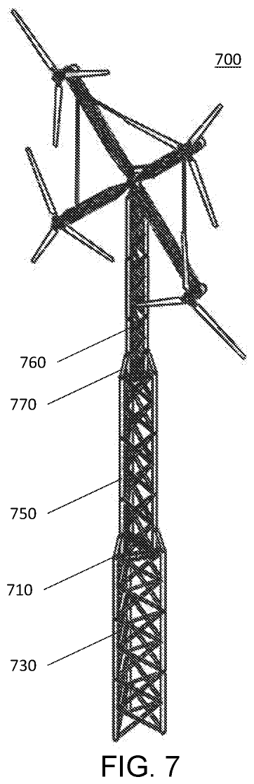

Referring now to FIG. 7, a self-erecting structure system 700 according to an embodiment of the invention is presented. In the current embodiment, the self-erecting structure system 700 comprises a first internal structure apparatus 750 and a second internal structure apparatus 760. To facilitate the transition between the first and second internal transition apparatuses 750, 760 and the construction of at least the second internal structure apparatus, the self-erecting structure system 700 may comprise a second platform member 770. The second platform member 770 may be substantially identical to the platform members described hereinabove. Moreover, the self-erecting structure system 700 may comprise a first platform member 710 to facilitate in the construction of and transition between the external structure apparatus 730 and the first internal structure apparatus 750. The second platform member 770 may include the same constituent elements necessary for the construction of the second internal structure apparatus 760, including inner and outer apertures, internal and external structure locking devices, and primary and secondary lifting systems.

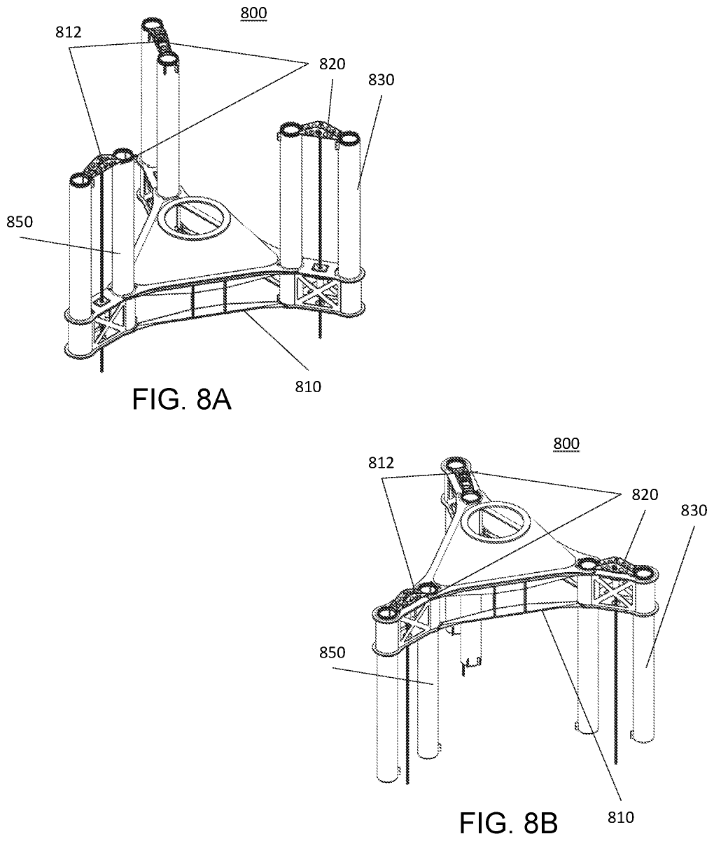

Referring now to FIGS. 8A-B, a further embodiment of a self-erecting structure system 800 is presented. The self-erecting structure system 800 comprises a platform member 810, and external structure apparatus 830, and an internal apparatus member 850 as described above. In the present embodiment, the system 800 further comprises one or more bridge members 820. The bridge members 820 may be configured to be positioned on the upper ends of adjacent legs of the external and internal structure apparatuses 830, 850. The bridge members 820 may be configured to extend between the adjacent legs of the external and internal structure apparatuses 830, 850 to provide a platform upon which the primary lifting devices of the primary lifting system 812 may be attached. Such bridge members 820 may advantageously distribute the weight and forces experienced during elevation of the platform member 810 and any load attached thereto between the external and internal structure apparatuses 830, 850, reducing the risk of failures.

It is contemplated and included within the scope of the invention that structures of differing heights may be constructed using the above-described systems and methods. Examples includes towers within a range from 120 meters to 180 meters, 120 meters to 200 meters, and 120 meters to 300 meters.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A self-erecting structure system comprising:
an external structure apparatus comprising:
a base module comprising:
a plurality of base leg members configured to fixedly attach to an anchoring structure at a lower end thereof; and
a plurality of bracing members configured to fixedly attach to adjacent base leg members;
a plurality of intermediate modules comprising:
a plurality of intermediate leg members configured to attach to at least one of an upper end of a base leg member and an upper end of an intermediate leg member at a lower end thereof;
a plurality of bracing members configured to fixedly attach to adjacent intermediate leg members; and
an upper module comprising:
a plurality of upper leg members; and
a plurality of bracing members configured to fixedly attach to adjacent upper leg members;
an internal structure apparatus configured to be temporarily be positioned within an area bounded by the external structure apparatus, the internal structure apparatus comprising a plurality of internal structure modules; and
a platform member comprising:
an inner aperture within which the internal structure apparatus may pass through;
an internal structure locking device configured to lock the platform member to the internal structure;
a plurality of outer apertures through which one of a base leg member, and intermediate leg member, and an upper leg may pass through;
a plurality of external structure locking devices configured to lock the platform member to at least one of the base leg members, the intermediate leg members, and the upper leg members;
a primary lifting system configured to removably attach to one of the external structure apparatus and internal structure apparatus to elevate the platform member; and
a secondary lifting system configured to removably attach to an upper module or a portion thereof or an internal structure module, and further configured to lift the upper module and portions thereof, and internal structure modules and portions thereof;
wherein one of the primary lifting system and the second lifting system is configured to raise the internal structure apparatus until a lower end thereof can be fixedly attached to the platform member; and
wherein the platform member is configured to fixedly attach to the lower end of the internal structure apparatus in an installed configuration.

2. The self-erecting structure system of claim 1 wherein the platform member comprises:
a center member comprising the inner aperture; and
a plurality of platform arms extending outward from the center member, the plurality of platform arms each comprising an outer aperture of the plurality of outer apertures.

3. The self-erecting structure system of claim 1 wherein the primary lifting system comprises a plurality of primary lifting devices.

4. The self-erecting structure system of claim 3 wherein:
the plurality of primary lifting devices comprises a number of primary lifting devices equal in number to the number of arms comprised by the plurality of outer apertures and fixedly attached to the platform member.
each primary lifting device is fixedly attached to an arm of the plurality of arms.

5. The self-erecting structure system of claim 3 wherein at least one primary lifting device of the plurality of primary lifting devices comprises a crane apparatus.

6. The self-erecting structure system of claim 1 wherein the primary lifting system comprises a least one of a strand jack, a rack and pinion system, a winch, a hoist, a pinned climbing jack system, a lifting ratchet system, an electric linear actuator, a hydraulic linear actuator, and a reciprocating hydraulic ram.

7. The self-erecting structure system of claim 1 wherein the secondary lifting system comprises a plurality of secondary lifting devices.

8. The self-erecting structure system of claim 7 wherein:
the plurality of secondary lifting devices comprises a number of secondary lifting devices equal in number to the number of outer apertures fixedly attached to the platform member.

9. The self-erecting structure system of claim 7 wherein at least one secondary lifting device of the plurality of secondary lifting devices comprises a crane apparatus.

10. The self-erecting structure system of claim 1 wherein
the platform member comprises a load attachment apparatus configured to attach to a load; and
the load is elevated as the platform member is elevated.

11. The self-erecting structure system of claim 1 wherein:
the internal structure apparatus is cylindrical; and
the inner aperture is positioned at a center of the center member.

12. The self-erecting structure system of claim 1 wherein:
the internal structure apparatus is a lattice structure comprising:
a plurality of internal leg members; and
a plurality of internal bracing members configured to fixedly attach to adjacent internal leg members; and
the platform member comprises a plurality of inner apertures configured to permit an internal leg member of the plurality of internal leg members to pass therethrough.

13. The self-erecting structure system of claim 1 wherein at least one of the plurality of outer apertures is configured to facilitate the a base leg member, an intermediate leg member, or an upper leg member positioned to be non-parallel with the other leg members and non-orthogonal to a plane defined by the platform member.

14. The self-erecting structure system of claim 1 wherein each of the primary lifting system and the secondary lifting system comprises at least one of a hydraulic system, a pneumatic system, and an electrical system.

15. The self-erecting structure system of claim 1 wherein each of the primary lifting system and the secondary lifting system comprises at least one of a linear system and a rotary system.

16. The self-erecting structure system of claim 1 further comprising:
a second internal structure apparatus configured to be temporarily be positioned within an area bounded by the internal structure apparatus, the second internal structure apparatus comprising a plurality of second internal structure modules; and
a load comprising a second platform member, the second platform member comprising:
an inner aperture within which the second internal structure apparatus may pass through;
a second internal structure locking device configured to lock the second platform member to the second internal structure;
a plurality of second outer apertures through which a leg member of the internal structure may pass through;
a plurality of second external structure locking devices configured to lock the second platform member to a leg member of the internal structure;
a primary lifting system configured to removably attach to one of the internal structure apparatus and the second internal structure apparatus to elevate the second platform member; and
a secondary lifting system configured to removably attach to an upper module or a portion thereof or an internal structure module to raise the upper module or portion thereof of internal structure module to the second platform member.

17. A method of constructing a structure comprising:
positioning above an anchoring structure a platform member comprising:
an inner aperture;
an internal structure locking device;
a plurality of outer apertures;
a plurality of external structure locking devices;
a primary lifting system; and
a secondary lifting system;
positioning a plurality of base leg members of a base module through the outer apertures;
attaching a lower end of the plurality of base leg members to the anchoring structure;
attaching the primary lifting system to at least one of the base leg members of the plurality of base leg members;
elevating the platform member to an upper end of the plurality of base leg members using the primary lifting system;
lifting a plurality of intermediate leg members to the platform member using the secondary lifting system;
fixedly attaching a lower end of the plurality of intermediate leg members to the upper end of the plurality of base leg members;
elevating the platform member to an upper end of the plurality of intermediate leg members using the primary lifting system;
lifting a plurality of upper leg members to the platform member using the secondary lifting system;
fixedly attaching a lower end of the plurality of upper leg members to the upper end of the plurality of intermediate leg members;
elevating the platform member to an upper end of the plurality of upper leg members using the primary lifting system;
fixedly attaching the platform member to an upper end of the upper leg members;
lifting an internal structure apparatus using one of the primary lifting system and the second lifting system; and
fixedly attaching the internal structure apparatus to the platform member.

18. The method of constructing a structure of claim 17 further comprising:
attaching a load to the platform member;
attaching the load to an upper end of the internal structure apparatus; and
detaching the load from the platform member prior to lifting the internal structure apparatus.

19. The method of constructing a structure of claim 18 wherein the load is attached to the platform member at a location remote from the anchoring structure, the method further comprising transporting the platform member with the load attached thereto to the anchoring structure.

20. The method of constructing a structure of claim 17 wherein the anchoring structure is at least one of caissons, piles, piers, drilled shafts, footings, and any other foundation.

21. The method of constructing a structure of claim 17 wherein the anchoring structure is operable to move itself and constructed structure attached thereto, the method further comprising operating the anchoring structure to move the constructed structure.

22. A self-erecting structure system comprising:
an external structure apparatus comprising:
a base module comprising:
a plurality of base leg members configured to fixedly attach to an anchoring structure at a lower end thereof; and
a plurality of bracing members configured to fixedly attach to adjacent base leg members;
a plurality of intermediate modules comprising:
a plurality of intermediate leg members configured to attach to at least one of an upper end of a base leg member and an upper end of an intermediate leg member at a lower end thereof;
a plurality of bracing members configured to fixedly attach to adjacent intermediate leg members; and
an upper module comprising:
a plurality of upper leg members; and
a plurality of bracing members configured to fixedly attach to adjacent upper leg members;
an internal structure apparatus configured to be temporarily be positioned within an area bounded by the external structure apparatus, the internal structure apparatus comprising a plurality of internal structure modules; and
a platform member comprising:
a center member comprising an inner aperture within which the internal structure apparatus may pass through;
an internal structure locking device configured to lock the platform member to the internal structure;
a plurality of arms extending outward from the center member, each arm comprising an outer aperture through which one of a base leg member, an intermediate leg member, and an upper leg may pass through;
a plurality of external structure locking devices configured to lock the platform member to at least one of the base leg members, the intermediate leg members, and the upper leg members;
a primary lifting system configured to removably attach to one of the external structure apparatus and internal structure apparatus to elevate the platform member; and
a secondary lifting system comprising a plurality of secondary lifting systems configured to removably attach to an upper module or a portion thereof or an internal structure module, and further configured to lift the upper module and portions thereof, and internal structure modules and portions thereof, each secondary lifting system fixedly attached to an arm of the plurality of arms;
wherein one of the primary lifting system and the second lifting system is configured to raise the internal structure apparatus until a lower end thereof can be fixedly attached to the center member;
wherein at least one secondary lifting device of the plurality of secondary lifting devices comprises a crane apparatus; and
wherein the center member is configured to fixedly attach to the lower end of the internal structure apparatus in an installed configuration.
